(19) United States
(12) Patent Application Publication
(10) Pub. No.: US 2024/0362421 A1
(43) Pub. Date: Oct. 31, 2024

(54) SYSTEMS AND METHODS FOR LANGUAGE MODEL-BASED CONTENT CLASSIFICATION

(71) Applicant: OpenAI Opco, LLC, San Francisco, CA (US)

(72) Inventors: Todor MARKOV, San Francisco, CA (US); Chong ZHANG, Redwood City, CA (US); Sandhini AGARWAL, San Francisco, CA (US); Florentine Mary ELOUNDOU NEKOUL, San Francisco, CA (US); Theodore LEE, Menlo Park, CA (US); Steven ADLER, San Francisco, CA (US); Angela JIANG, San Francisco, CA (US); Lilian WENG, Hillsborough, CA (US)

(73) Assignee: OpenAI Opco, LLC, San Francisco, CA (US)

(21) Appl. No.: 18/308,586

(22) Filed: Apr. 27, 2023

(51) Int. Cl. G06F 40/40; G06F 40/205; G06F 40/284

(52) U.S. Cl. CPC G06F 40/40; G06F 40/205; G06F 40/284

(57) ABSTRACT

Disclosed herein are methods, systems, and computer-readable media for automatically classifying and moderating content. In an embodiment, a method may include receiving input data and one or more content policies, and generating a content taxonomy. The method may also include receiving multi-domain cold start data and generating training data. The method may also include accessing a language model based on the input data and the training data, and iteratively classifying the content of the input data using the language model and the content taxonomy, refining the training data based on the classified content of the input data, refining the language model based on the refined training data, probing the refined language model, and updating the threshold value based on the probing of the refined language model. The method may also include moderating the content of the input data based on the optimized language model and the content taxonomy.

### CROSS-REFERENCE TO RELATED DOCUMENTS

A non-patent literature document, “A Holistic Approach to Undesired Content Detection in the Real World” by Todor Markov et al. (citation number arXiv: 2208.03274v1), is also incorporated herein by reference in its entirety.

### FIELD OF DISCLOSURE

The disclosed embodiments generally relate to systems, devices, methods, and computer readable media for automatically classifying and moderating content using a language model-based approach.

### BACKGROUND

Large language models (LMs) can be prompted or instructed to perform a range of natural language processing (NLP) tasks, given some examples of the task as input. Many conventional LMs and related systems, however, lack the capabilities to accurately understand natural language input and rapidly implement text or code changes in response to such input. conventional LMs are often configured for very specific tasks as well, and lack the flexibility to respond to a broad range of natural language inputs. Moreover, many LMs are not well integrated with APIs or trained on well-tailored datasets, leading to poor predictive results and lack of integration with other systems.

The disclosed embodiments address one or more of these shortcomings, as well as others that are readily apparent. For instance, a robust LM-based natural language classification system capable of detecting a broad set of categories of undesired content, including sexual content, hateful content, violence, self-harm, and harassment, may be useful for real-world content moderation. Such a system may utilize design of content taxonomies and labeling instructions, data quality control, an active learning pipeline to capture rare events, and a variety of LM-based methods to make the model robust and to avoid overfitting.

### SUMMARY

Embodiments of the present disclosure present technological improvements as solutions to one or more of the above-mentioned technical problems recognized by the inventors in conventional systems. For example, in an embodiment, a non-transitory computer-readable medium may include instructions that are executable by one or more processors to perform operations for automatically classifying and moderating content. The operations may include receiving input data, receiving one or more content policies, and generating a content taxonomy based on the one or more content policies. The operations may also include receiving multi-domain cold start data from a plurality of data sources and generating training data based on the multi-domain cold start data. The operations may also include accessing a language model based on the input data and the training data. The operations may also include iteratively executing second operations until a threshold value has been reached to generate an optimized language model, wherein the second operations comprise: classifying the content of the input data using the language model and the content taxonomy, refining the training data based on the classified content of the input data, refining the language model based on the refined training data, probing the refined language model, and updating the threshold value based on the probing of the refined language model. The operations may also include moderating the content of the input data based on the optimized language model and the content.

According to some disclosed embodiments, generating the training data comprises annotating data.

According to some disclosed embodiments, the content taxonomy comprises one or more content categories.

According to some disclosed embodiments, the one or more content categories further comprise one or more sub-categorical layers.

According to some disclosed embodiments, the one or more sub-categories in a sub-categorical layer are ranked by a metric.

According to some disclosed embodiments, the training data comprises at least one of machine-generated data or human-curated synthetic data.

According to some disclosed embodiments, refining the training data comprises validating the training data and input data using at least one of cross validation or token subtraction.

According to some disclosed embodiments, refining the training data further comprises re-normalizing the training data based on language model-generated data or human-curated synthetic data.

According to some disclosed embodiments, probing the refined language model comprises key token probing and human verification.

According to some disclosed embodiments, moderating the content of the input data comprises filtering the content of the input data.

Other systems, methods, and computer-readable media are also discussed within.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram illustrating an exemplary system for automatically classifying and moderating text using a language-model based approach, according to some embodiments of the present disclosure.

FIG. 2 illustrates an exemplary content taxonomy for content categorization, including categories and subcategories, according to some embodiments of the present disclosure.

FIG. 3 illustrates an exemplary prompt template for generating synthetic data, according to some embodiments of the present disclosure.

FIG. 4 illustrates exemplary training data which may cause the language model to make predictions based on incorrect features, according to some embodiments of the present disclosure.

FIG. 5 illustrates an exemplary iterative process for automatically performing content classification and content moderation, according to some embodiments of the present disclosure.

FIG. 6 is a block diagram illustrating an exemplary operating environment for implementing various aspects of this disclosure, according to some embodiments of the present disclosure.

FIG. 7 is a block diagram illustrating an exemplary machine learning platform for implementing various aspects of this disclosure, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently. Reference will now be made in detail to the disclosed embodiments, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operation to perceive, synthesize, infer, predict, and/or generate information. AI systems may use one or more models, which may have a particular configuration (e.g., model parameters and relationships between those parameters, as discussed below). While a model may have an initial configuration, this configuration can change over time as the model learns from input data (e.g., training input data), which allows the model improve its abilities. For example, a dataset may be input to a model, which may produce an output based on the dataset and the configuration of the model itself. Then, based on additional information (e.g., an additional input dataset, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously navigate vehicles, automatically recognize objects, instantly generate natural language, understand human speech, and generate artistic images.

LMs of various capabilities, described herein, may be utilized to improve the versatility and robustness of Application Programming Interfaces (APIs) to perform a multitude of tasks involving understanding or generating natural language or code. For instance, the model may be used to edit text given a prompt and an instruction from the user, thus providing a natural interface for translating and tweaking text, as well as for refactoring and working with code. The model may also be used to insert text within text by providing a suffix prompt in addition to a prefix prompt, when writing long-form text, transitioning between paragraphs, following an outline, guiding the model towards an ending, or inserting code in the middle of a function or file. Illustrative embodiments of the present disclosure are described below. While some embodiments may be described with respect to “text” or “code,” it should be noted that such embodiments may apply to both text and code (e.g., computer code), as well as any digital information comprising one or more characters.

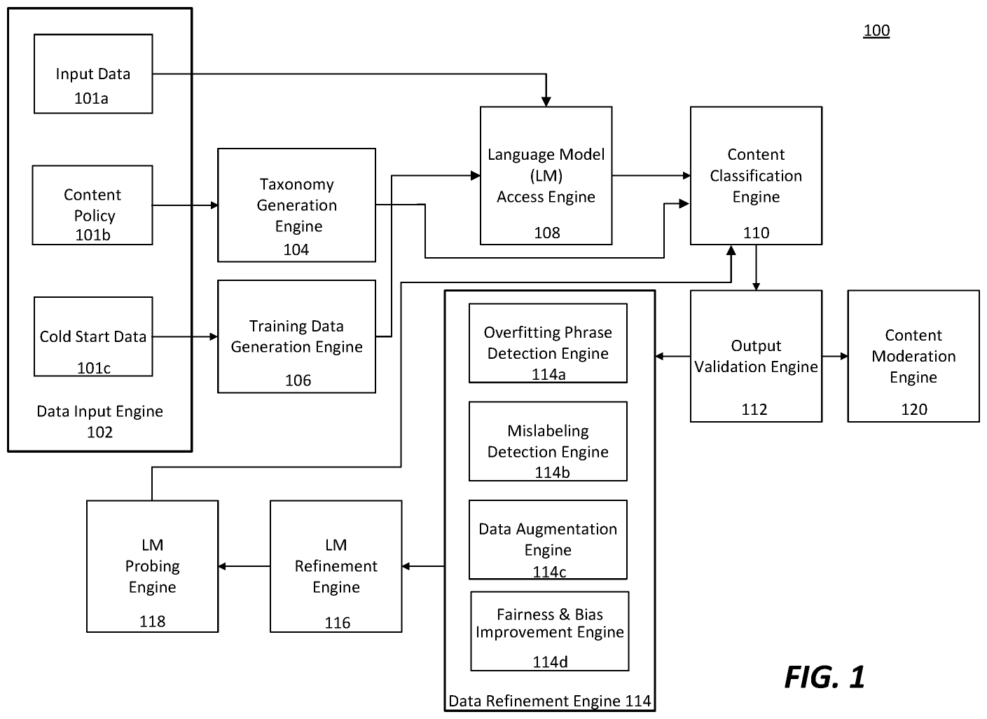

FIG. 1 is a block diagram illustrating an exemplary system for automatically classifying and moderating text using a language-model based approach, according to some embodiments of the present disclosure.

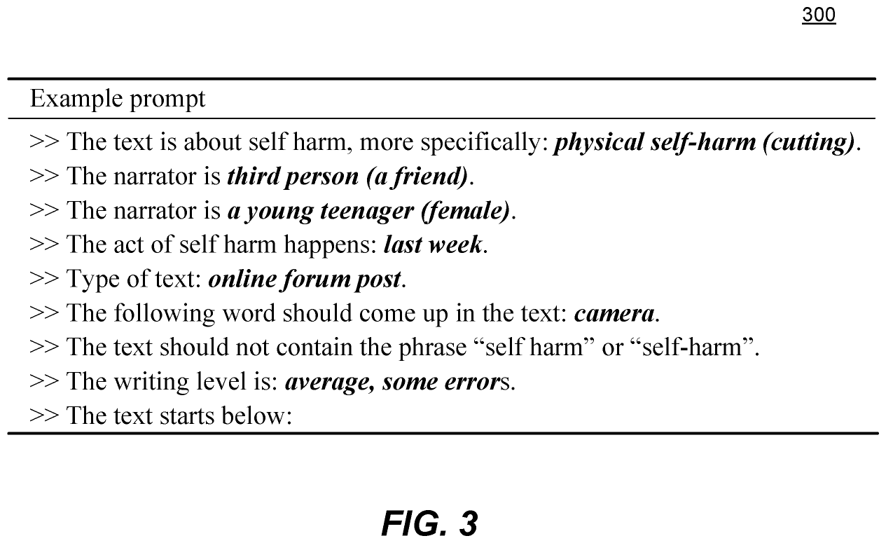

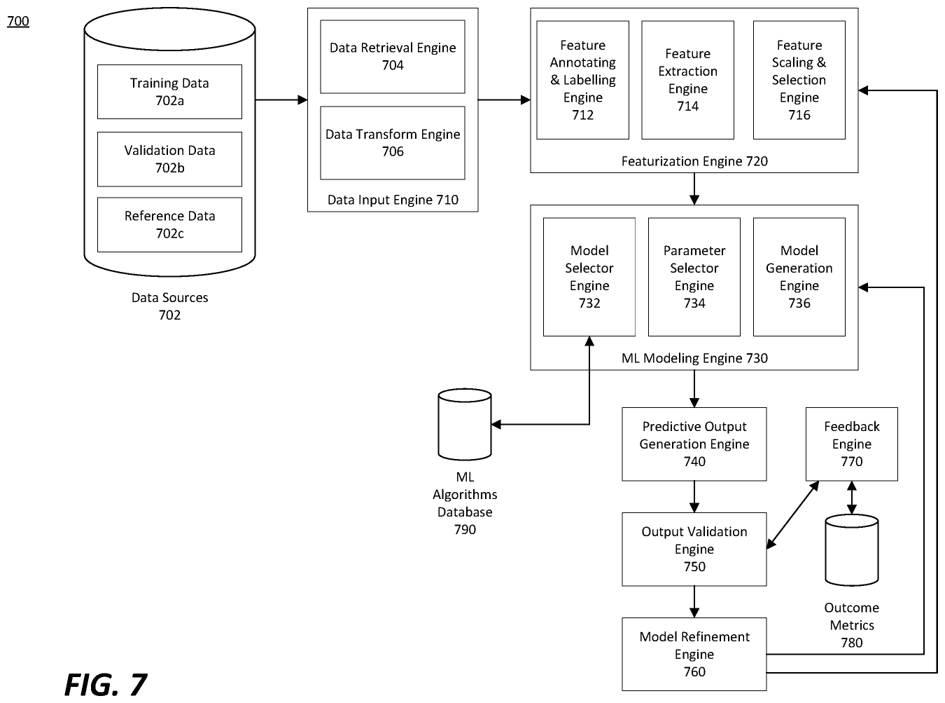

System 100 can include data input engine 102. As discussed below with respect to FIG. 7, an engine may be a module (e.g., a program module), which may be a packaged functional hardware unit designed for use with other components (e.g., at least one processor and a memory component) or a part of a program that performs a particular function (e.g., of related functions). Data input engine 102 may be configured to obtain data directly from external users. Data input engine 102 may be configured to obtain input data 101a. Input data 101a may comprise at least one of text data, image data, or video data. Data input engine 102 may be configured to obtain content policy 101b. Content policy 101b may comprise one or more sets of rules or guidelines for identifying and filtering content data. In some embodiments, the content data (e.g., digital information) may comprise input data 101a. In some embodiments, the content data may comprise data from one or more types of content categories, such as sexual content, hateful content, violence (violent content), self-harm content, harassment content, or benign content. A content policy may include at least one of an instruction, a defined task, or any combination of parameters that set one or more constraints on language model output. In some embodiments, a content policy may include user-specified natural language instructions. For instance, a user instruction may comprise filtering out content data of a certain category, such as hateful content or sexual content. In some embodiments, user input data or user instruction may correspond to a particular language model application framework (e.g., which may include a digital text pattern, format, structure, or style). In some embodiments, an Application Programming Interface (API) may define the particular language model application framework. Data input engine 102 may also obtain cold start data 101c. In some embodiments, in place of cold start data, other forms of data may be used (e.g., as part of a model training process). Cold start data 101c may be multi-domain data, comprising data from a plurality of data sources. In some embodiments, cold start data 101c may comprise machine-generated data or human-curated synthetic data. In some embodiments, human-curated synthetic data may be generated using a prompt template as exemplified by FIG. 3. In some embodiments, cold start data 101c may be used by a training data engine such as training data generation engine 106 to generate cold start data to initiate an active learning and/or labelling process for a language model. In some embodiments, active learning may comprise parallel learning. For instance, active learning may be performed based on three parallel learning pipelines. Under this model, the first pipeline be configured to may perform random sampling of the cold start data to ensure consistency with the underlying data distribution in production. The second pipeline may be configured to perform random sample selection from samples with model score above a certain threshold for each category to identify likely undesired data points. The last pipeline may be configured to adopt a set of uncertainty sampling strategies (e.g., algorithms) to capture samples that the model is most uncertain about above a certain model score threshold.

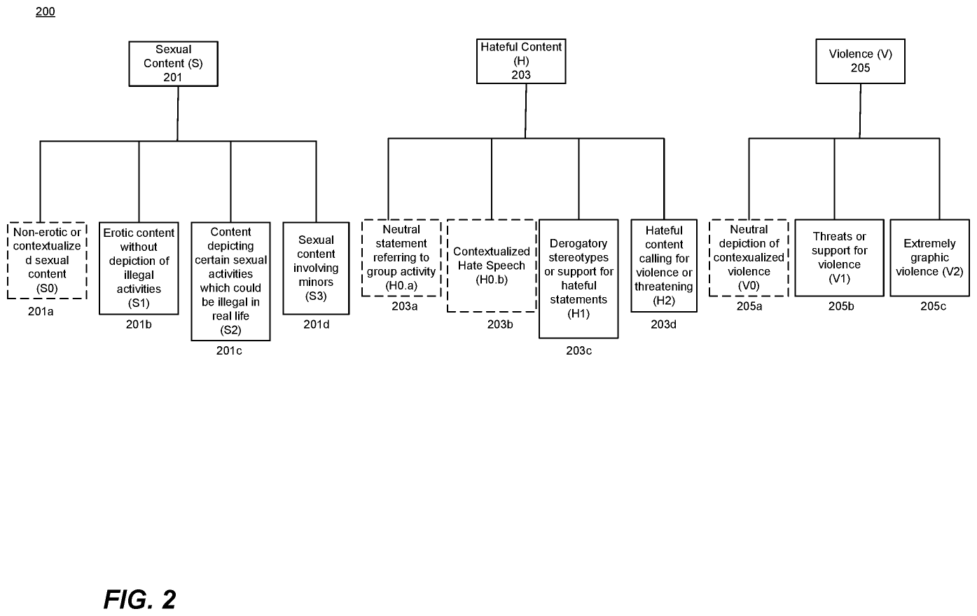

System 100 can further include taxonomy generation engine 104. In some embodiments, taxonomy generation engine 104 may be configured to receive input data as exemplified by input data 101a. In some embodiments, taxonomy generation engine 104 may receive one or more content policies as exemplified by content policy 101b. Taxonomy generation engine 104 may automatically generate a taxonomy of content based on input data 101a and content policy 101b. In some embodiments, the taxonomy generated may comprise undesired content which may undergo content moderation. In some embodiments, the taxonomy generated may comprise one or more content categories such as sexual content, hateful content, or violent content, as exemplified by FIG. 2. In some embodiments, the taxonomy generated may further comprise one or more content sub-categorical layers. For instance, a content category of sexual content [S] may be defined as content that depicts explicit or implicit sexual behavior. The content category of sexual content [S] may comprise a sub-categorical layer further comprising [S3] sexual content involving minors, [S2] content that depicts certain sexual activities which could be illegal if they happened in real life today, and [S1] erotic sexual content that does not depict illegal activities and [S0] nonerotic or contextualized sexual content, such as medical or sex education material. In some embodiments, a subset of sub-categories within a sub-categorical layer may be labelled as “undesired”, such as S1-S3 above. In some embodiments, a subset of sub-categories within a sub-categorical layer may not receive the “undesired” label. In another example, a content category of hateful content [H] may comprise content that is threatening, insulting, derogatory and otherwise abusive content targeting specific chosen groups or members of the group because of their group identifies. Content category hateful content [H] may comprise a sub-categorical layer comprising undesired sub-categories such as [H2] hateful content calling for violence or threatening, [H1] derogatory stereotypes or support for hateful statements, and/or subcategories that are not considered as undesired, such as [H0.a] neutral statement referring to group identity and [H0.b] contextualized hate speech, such as a quote of other individual's statement in order to provide commentary. In another example, a content category of violence [V] may comprise content that depicts or shows support for physical violence. The content category of violence [V] may comprise a sub-categorical layer comprising undesired sub-categories such as [V2] extremely graphic violence and [V1] threats or support for violence, and/or sub-categories such as [V0] neutral depictions of contextualized violence which may not be considered undesired. In some embodiments, the categories or sub-categories in a sub-categorical layer may be ranked by a metric. In some embodiments, the metric may comprise a measure of a degree to which the content is desired or undesired or a prediction of the content as including desired or undesired digital material. In some embodiments, the metric may be user-defined or machine-generated. In some embodiments, the metric may be automatically generated based on training data or cold start data as exemplified by cold start data 101c. It is appreciated that this automatic taxonomy generation and/or automatic metric-based ranking of generated content categories and sub-categories within the taxonomy implements a solution rooted in computer technology rather than simply following rules, and contribute to solving the complex problem of accurate content taxonomy generation and ranking across a multitude of types of categories and sub-categorical layers.

System 100 can further include training data generation engine 106. In some embodiments, training data generation engine 106 may receive unlabeled data or raw data as exemplified by cold start data 101c. In some embodiments, training data generation engine 106 may receive multi-domain training data from a plurality of data sources. In some embodiments, training data may comprise crawled data or data mined from one or more web sources, such as HyperText Markup Language (HTML) data or JavaScript data, which is often impractical for human users to analyze, process, and manipulate. Additionally or alternatively, training data may also comprise public-domain data. Additionally or alternatively, training data may also comprise machine-generated data based on a language model. Additionally or alternatively, training data may also comprise human-curated synthetic data. In some embodiments, training data may be generated by using a zero-shot prompt approach. Additionally or alternatively, training data or other input data may be generated using a generative model such as GPT-3. In some embodiments, training data generation engine 106 may annotate the received cold start data. In some embodiments, annotating the received cold start data may comprise tokenization, lemmatization, part-of-speech tagging, metadata generation, and/or any operation to modify distinguish certain data. In some embodiments, the at least one processor may perform additional normalization of the received cold start data, including but not limited to foreign language translation, conversion of system data or meta data, or masking of personal identifiable information. In some embodiments, training data generation engine 106 may generate a set of training data based on input data 101a and/or cold start data 101c. In some embodiments, training data generation engine 106 may generate a set of training data based on multi-domain data from a plurality of data sources, such as crawled data, public-domain data, or academic data. It is appreciated that this generation of training data from multiple data domains and data types improves natural-language-based machine learning model training by improving efficiency and resource usage, and presents a methodology to utilize web-based data, across a multitude of remote sources, which is frequently impractical for human analysis.

System 100 can further include language model access engine 108. In some embodiments, language model access engine 108 may be configured to access a language model (e.g., such as one of those discussed further herein), such as from a local or remote language model storage medium (e.g., ML algorithms database 790), based on one or more desired output behaviors or user intent, which may be encoded in content policy 101b. Additionally or alternatively, language model access engine 108 may initialize a language model from a generative model such as Generative Pre-trained Transformer 3 (GPT-3), Generative Pre-trained Transformer 3.5 (GPT-3.5), or Generative Pre-trained Transformer 4 (GPT-4). In some embodiments, the generative model may be pre-trained, for instance on text corpus data. Additionally or alternatively, the accessed language model may comprise a transformer decoder model. In some embodiments, the transformer decoder model may comprise a final output linear layer, which may contain multiple Multi-Perception Layer (MLP) heads. In some embodiments, an MLP head (e.g., each MLP head) may correspond to an independent matrix, which may have a shape of [d_{model}, 256, 1], where d_{model} corresponds to a size of the language model. Using an MLP head architecture improves over other architectures by reducing interference between categories and also requires fewer parameters to train. Additionally or alternatively, language model access engine 108 may be configured to access a language model based on one or more content policies derived from content policy 101b. Additionally or alternatively, language model access engine 108 may be configured to access a language model based on a set of user-defined or system-defined model parameters. Additionally or alternatively, language model access engine 108 may be configured to access a language model based on the output of content classification as performed by content classification engine 110 or the validated output from output validation engine 112. Additionally or alternatively, language model access engine 108 may be configured to access the language model based on a training dataset produced by training data generation engine 106, which may include sample data input. In some embodiments, the training dataset may also include sample output data based on the sample data input. In some embodiments, the training dataset may also include annotated data, labeled data, or other types of enriched or augmented data. In some embodiments, accessing the language model may include at least one of adding, removing, modifying a model parameter of the language model, or any other model training operation discussed below, such as with respect to FIG. 7. For example, language model access engine 108 may add, deactivate. or remove a node and/or layer of the model. As another non-mutually exclusive example, language model access engine 108 may add or remove a connection between nodes within the language model. In some embodiments, language model access engine 108 may execute (e.g., perform) access of the language model based on a set of demonstration data. In some embodiments, language model access engine 108 may use the cold start data or other multi-domain data as validation data to determine quality scores or other metrics of model output, to train a language model to perform improved content classification. It is appreciated that this automatic validation and training of the language model improves natural-language-based machine learning model training and output by improving efficiency and accuracy. In some embodiments, language model access engine 108 may execute (e.g., perform) alignment using a machine learning algorithm. In some embodiments, the machine learning algorithm may include a reinforcement learning algorithm, such as proximal policy optimization. In some embodiments, aligning the language model may include maximizing a helpfulness metric of one or more model outputs. In some embodiments, a helpfulness metric of the one or more outputs may be computed (e.g., by at least one processor) based on labelled data (e.g., by executing one or more comparisons between one or more outputs and the labelled data associated with respective helpfulness metrics). In some embodiments, the labelled data may comprise human-curated synthetic data or machine-generated data based on a language model. In some embodiments, aligning the language model may include maximizing an outcome metric of one or more model outputs. In some embodiments, the outcome metrics of the one or more outputs may be computed based on user-labeled data (e.g., by executing one or more comparisons between one or more outputs and user-labeled data associated with respective outcome metrics). In some embodiments, the language model is configured to output the language model output based on at least one of a sampling temperature parameter or a nucleus sampling parameter. In some embodiments, the language model is configured to output language model output based on the probability of the output in a probability distribution of a sampling temperature parameter or a nucleus sampling parameter. In some embodiments, the language model output may comprise a probability of one or more classifications of input data as exemplified by input data 101a.

System 100 can further include content classification engine 110. In some embodiments, content classification engine 110 may be configured to receive data from language model access engine 108 and data from taxonomy generation engine 104. In some embodiments, content classification engine 110 may be configured to classify input data as exemplified by input data 101a. In some embodiments, content classification engine 110 may perform classification of input data based on the taxonomy generated by taxonomy generation engine 104, comprising one or more categories and/or sub-categorical layers which comprise one or more sub-categories. For instance, content classification engine 110 may classify input data as sexual content [S], hateful content [H], and/or violence [V]. Content classification engine 110 may further classify input data under the [S] category as non-erotic or contextualized sexual content [S0], erotic content without depiction of illegal activities [S1], content depicting certain activities which could be illegal in real life [S2], and/or or sexual content involving minors [S3], as illustrated in FIG. 2. In some embodiments, content classification engine 110 may be configured to classify input data as multiple categories and/or sub-categories within one or more sub-categorical layers. In some embodiments, content classification engine 110 may be configured to classify input data as “undesired” based on its associated categories and/or sub-categories. For instance, under the category [S], input data of sub-categories [S1], [S2], and [S3] may be classified as “undesired” while input data of sub-sub-category [S0] may not be classified as “undesired.”

System 100 can further include output validation engine 112. In some embodiments, output validation engine 112 may be configured to receive output content classifications from content classification engine 110. In some embodiments, output validation engine 112 may receive at least one of a set of language model outputs, user-labelled outputs, or a set of comparison data. Output validation engine 112 may be configured to execute a ranking of the received outputs, such as based on a set of user instructions or one or more content policies as exemplified by content policy 101b. Additionally or alternatively, output validation engine 112 may be configured to execute ranking based on a set of training data generated by training data generation engine 106 or cold start data 101c. Additionally or alternatively, output validation engine 112 may be configured to rank the received outputs based on an outcome metric. In some embodiments, an outcome metric may comprise a numerical scoring of the content classification from content classification engine 110. In some embodiments, the numerical scoring may be based on human-labelled data. An outcome metric may comprise machine-generated metrics based on one or more training data sets or multi-domain data. Additionally or alternatively, an outcome metric may comprise a similarity metric between the classification of the input data as received by content classification engine 110 and human-curated synthetic data. In some embodiments, output validation engine 112 may rank the received outputs based on a proximity metric to one or more desired output behaviors or one or more content policies. In some embodiments, output validation engine 112 may validate the received outputs by identifying mislabeled data, which may include at least one of using cross validation or token subtraction. In some embodiments, the received outputs may comprise training data generated by training data generation engine 106, or input data 101a.

System 100 can further include data refinement engine 114. In some embodiments, data refinement engine 114 may be configured to execute data refinement operations, such as by re-normalizing the training data. For example, data refinement engine 114 may be configured to re-normalize training data based on language model-generated data and/or human-curated synthetic data. In some embodiments, data refinement engine 114 may comprise overfitting phrase detection engine 114a (which, alternatively, may be a separate engine from data refinement engine 114). Overfitting phrase detection engine 114a may be configured to identify overfitted phrases in the training data using machine-generated data based on the language model or human-curated synthetic data. For instance, the phrase “Mary is hateful” in the context of the sentence “To say that Mary is hateful would be an unfair statement” may not be labelled as hateful content [H] by content classification engine 110. Thus, in this example, overfitting phrase detection engine 114a may identify the phrase “X is hateful” within the training data as an overfitted phrase because it is an over-generalized phrase. In some embodiments, overfitting phrase detection engine 114a may identify overfitted phrases by using token-subtraction and/or other input reduction techniques. In some embodiments, overfitting phrase detection engine 114a may identify overfitted phrases by using an adversarial approach such as by using an adversarial model or red-teaming via human trials. In some embodiments, the adversarial model may comprise Wasserstein Distance-Guided Domain Adversarial Training (WDAT). In some embodiments, the adversarial model may identify model weaknesses based on data scarcity or low prediction or classification accuracy. In some embodiments, model weakness may be identified by output validation engine 112 or LM probing engine 118. In some embodiments, the WDAT adversarial model may generate human-curated synthetic data to reduce model weakness.

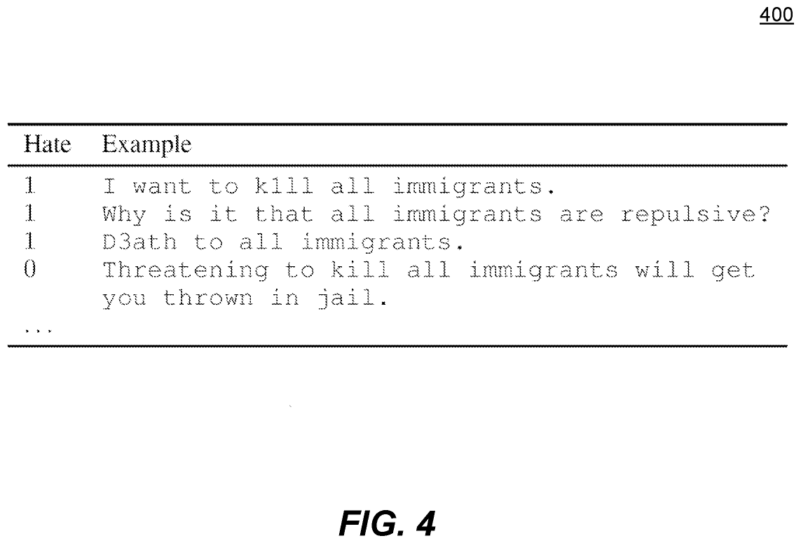

In some embodiments, data refinement engine 114 may comprise mislabeling detection engine 114b (which, alternatively, may be a separate engine from data refinement engine 114). In some embodiments, mislabeling detection engine 114b may be configured to identify input data or training data that has been incorrectly classified by content classification engine 110. For instance, as illustrated in FIG. 4, sentences 1-3 (i.e., “I want to kill all immigrants”, “why is it that all immigrants are repulsive?” and “D3ath to all immigrants”) may be classified by content classification engine 110 as hateful content [H]. However, sentence 4, “threatening to kill all immigrants will get you thrown in jail” may not be hateful content and a labeling of [H] by content classification engine 110 may be considered mislabeling. Thus, mislabeling detection engine 114b may identify an [H] category label for sentence 4 as a mislabel. In some embodiments, mislabeling detection engine 114b may identify mislabels using one or more of cross-validation, overfitted tokens, or phrases identified by overfitting phrase detection engine 114a.

In some embodiments, data refinement engine 114 may comprise data augmentation engine 114c. Data augmentation engine 114c may perform a data distribution analysis of the training data or cold start data. In some embodiments, data augmentation engine 114c may perform the data distribution analysis based on the distribution of data samples classified by content classification engine 110 for each category and/or sub-category within the content taxonomy as generated by taxonomy generation engine 104. In some embodiments, data augmentation engine 114c may base the data distribution analysis on the number of data samples within the data set classified as “undesired” by content classification engine 110. In some embodiments, data augmentation engine 114c may base the data distribution analysis on the frequency of irrelevant symbols, typos, or adversarial inputs in the data set. Data augmentation engine 114c may generate synthetic data using a language model based on the determined data distribution of the data set. For instance, data augmentation engine 114c may generate synthetic data for aspects of the data set which is sparse based on the data distribution, such as data for a particular type of category or sub-category. In some embodiments, data augmentation engine 114c may utilize one or more prompt templates to generate synthetic data as illustrated in FIG. 3.

In some embodiments, data refinement engine 114 may comprise fairness & bias improvement engine 114d. Fairness & bias improvement engine 114d may be configured to perform bias identification of the output content classification as performed by content classification engine 110. In some embodiments, fairness & bias improvement engine 114d be configured to may perform bias identification using demographical data based on one or more attributes. In some embodiments, demographical data may comprise data based on one or more of gender, age, or sexual orientation. For instance, fairness & bias improvement engine 114d may be configured to identify that the current language model used by content classification engine 110 generates higher percentage of hateful content [H] labels if the input data contains the word “gay”, or higher percentage of sexual content [S] labels if the input data contains “her.” In some embodiments, fairness & bias improvement engine 114d may refine the training data set by performing overfitting reduction using overfitting phrase detection engine 114a, mislabeling correction using mislabeling detection engine 114b, training data augmentation using data augmentation engine 114c, or any combination thereof.

System 100 can further include LM refinement engine 116. In some embodiments, LM refinement engine 116 may be configured to execute optimization operations, such as by aligning or fine-tuning a language model from language model access engine 108. In some embodiments, aligning or fine-tuning may be based on one or more desired output behaviors or user intent derived from a set of user instructions, or one or more content policies as exemplified by content policy 101b. In some embodiments, LM refinement engine 116 may be configured to align a language model based on the validated outputs from output validation engine 112 or the refined data set from data refinement engine 114. In some embodiments, aligning the language model may include at least one of adding, removing, modifying a model parameter of the language model, or any other model training operation discussed below, for example with respect to FIG. 7. For example, the at least one processor may add, deactivate, or remove a node and/or layer of the model. As another non-mutually exclusive example, the at least one processor may add or remove a connection between nodes within the language model. In some embodiments, LM refinement engine 116 may execute (e.g., perform) the alignment of the language model based on a set of machine-generated data based on a language model or human-curated synthetic data. In some embodiments, LM refinement engine 116 may use refined data as validation data to determine quality scores or other metrics of model output, to train a language model to generate improved digital text outputs or content classification. In some embodiments, LM refinement engine 116 may execute (e.g., perform) alignment using a machine learning algorithm. In some embodiments, the machine learning algorithm may include a reinforcement learning algorithm, such as proximal policy optimization. In some embodiments, aligning the language model may include maximizing a helpfulness metric of one or more model outputs. In some embodiments, a helpfulness metric of the one or more outputs may be computed (e.g., by at least one processor) based on labelled data (e.g., by executing one or more comparisons between one or more outputs and the labelled data associated with respective helpfulness metrics). In some embodiments, the labelled data may comprise human-curated synthetic data or machine-generated data based on a language model. In some embodiments, aligning the language model may include maximizing an outcome metric of one or more model outputs. In some embodiments, the outcome metrics of the one or more outputs may be computed based on user-labeled data (e.g., by executing one or more comparisons between one or more outputs and user-labeled data associated with respective outcome metrics). In some embodiments, the language model is configured to output the language model output based on at least one of a sampling temperature parameter or a nucleus sampling parameter. In some embodiments, the language model is configured to output language model output based on the probability of the output in a probability distribution of a sampling temperature parameter or a nucleus sampling parameter. In some embodiments, the language model output may comprise a probability of one or more classifications of input data as exemplified by input data 101a.

In some embodiments, LM refinement engine 116 may undergo iterative training and optimization of the language model. For example, the language model may be refined or optimized through one or more iterative cycles of training, which may be based on or more datasets (e.g., different datasets, such as different input or validation data). A cycle of training may include one or more rounds of training, one or more epochs of training, or any number of discrete training operations. In other embodiments, LM refinement engine 116 may perform training and optimization of the language model in a non-iterative manner. Alternatively, the language model may already be trained and/or optimized. LM refinement engine 116 may also train and optimize the language model by aligning a language model (e.g., the selected language model) to one or more desired output behavior (e.g., user intent, textual context, or one or more content policies as in 101b). The refined language model from LM refinement engine 116 may be used by content classification engine 110 to generate a set of refined content classifications for input data 101a in iterative cycles of generation, validation, and refinement.

System 100 can further include LM probing engine 118. In some embodiments, LM probing engine 118 may probe the accessed language model by language model access engine 108 or the refined language model by LM refinement engine 116. In some embodiments, LM probing engine 118 may probe the refined language model using key tokens probing to identify potentially over-fitted key tokens within the training data. In some embodiments, LM probing engine 118 may also apply token subtraction or other input reduction techniques. In some embodiments, LM probing engine 118 may probe the refined language model using human verification and adversarial approaches such as red-teaming via human trials.

System 100 can further include content moderation engine 120. In some embodiments, content moderation engine 120 may perform content moderation on input data 101a by filtering the input data based on the categories and/or subcategories of the input data classified as “undesired” by content classification engine 110. In some embodiments, content moderation engine 120 may perform content moderation by generating warnings to the user based on the categories and/or subcategories of the input data classified as “undesired” by content classification engine 110. In some embodiments, content moderation engine 120 may edit the input data to minimize the undesired content as classified by content classification engine 110.

FIG. 2 illustrates an exemplary content taxonomy for content categorization, including content categories and one or more sub-categorical layers comprising one or more sub-categories, according to some embodiments of the present disclosure. For instance, top-level content categories may comprise Sexual Content(S), Hateful Content (H), or Violence (V). Similarly, sub-categories within a sub-categorical layer may comprise S0-S3, H0.a-b, H1-2, and V0-V2. In some embodiments, a subset of sub-categories may be classified or labelled as “undesired” (e.g., [S3] sexual content involving minors; [S2] content that depicts certain sexual activities which could be illegal if occurring in real life today, and [S1] erotic sexual content that does not depict illegal activities. In some embodiments, a subset of sub-categories may not be classified or labelled as “undesired”, such as [S0] Non-erotic or contextualized sexual content, such as medical or sex education materials, as illustrated in FIG. 2 (dashed-bordered box). Similarly, under the category of Hateful Content (H), H1 and H2 may comprise a subset that is undesired while H0.a and H0.b are not considered undesired, and under Violence (V), V1 and V2 may comprise a undesired subset while V0 may not be considered undesired. While FIG. 2 shows one exemplary taxonomy, it is appreciated that taxonomies with hundreds, thousands, or more parameters (e.g., categories and sub-categories) may be used.

FIG. 3 illustrates an exemplary prompt template for generating cold start training data, according to some embodiments of the present disclosure. In some embodiments, training data generation engine 106 may use a prompt template to generate cold start data to initiate an active learning and/or labelling process for a language model. In some embodiments, the prompt template may be crafted by a human operator. In some embodiments, cold start data may comprise human-curated synthetic data. Additionally or alternatively, cold start data may comprise machine-generated data. As illustrated in FIG. 3, the prompts may be constructed from human-crafted templates, with random (e.g., randomly machine-generated) ingredients (shown in bold) used to encourage diversity. In some embodiments, the generated texts from prompts may be labelled automatically (e.g., by content classification engine 110) or manually by a human operator. In some embodiments, the generated texts may be used as training data by training data generation engine 106. In some embodiments, as shown in FIG. 1, data augmentation engine 114c may use one or more prompt templates to generate synthetic data for the cold start data or a training data set based on the data distribution of the data set to reduce imbalance from data sparsity.

FIG. 4 illustrates exemplary training data which may cause the language model to make predictions based on incorrect features, according to some embodiments of the present disclosure. For instance, while the first three sentences in the training data may be correctly classified as “hate” content, the last sentence may be incorrectly classified by a language model as “hate” based on the classification of the token “all immigrants” in the previous three examples. In some embodiments, key tokens probing may be performed by LM Probing Engine 118, Overfitting Phrase Detection Engine 114a, or Mislabeling Detection Engine 114b. In some embodiments, key tokens probing may identify potentially over-fitted key tokens, such as “all immigrants” in this instance. In some embodiments, Data refinement engine 114 or LM refinement engine 116 may apply input reduction on a training dataset.

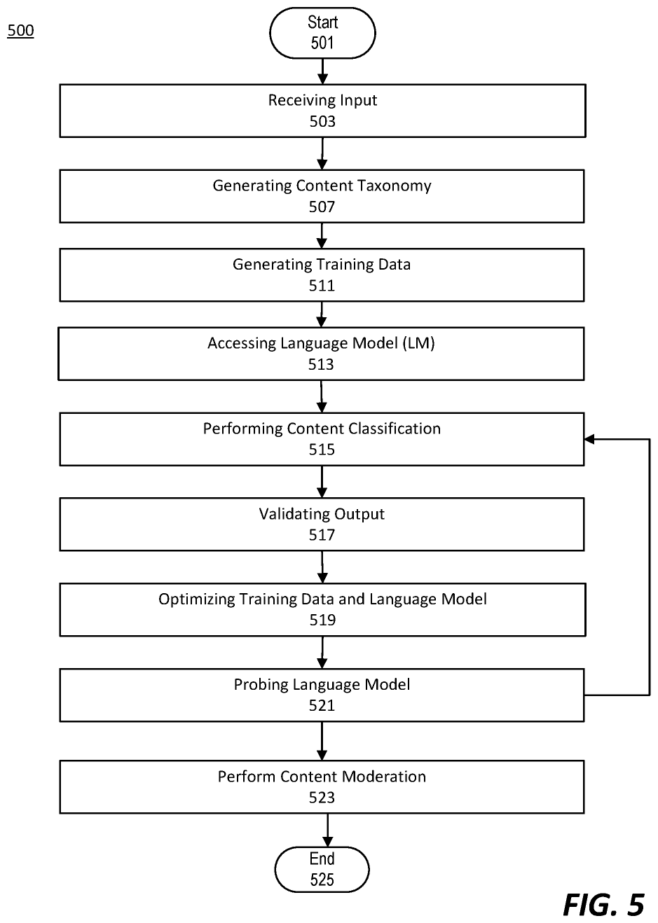

FIG. 5 illustrates an exemplary iterative process for automatically performing content classification and content moderation, according to some embodiments of the present disclosure.

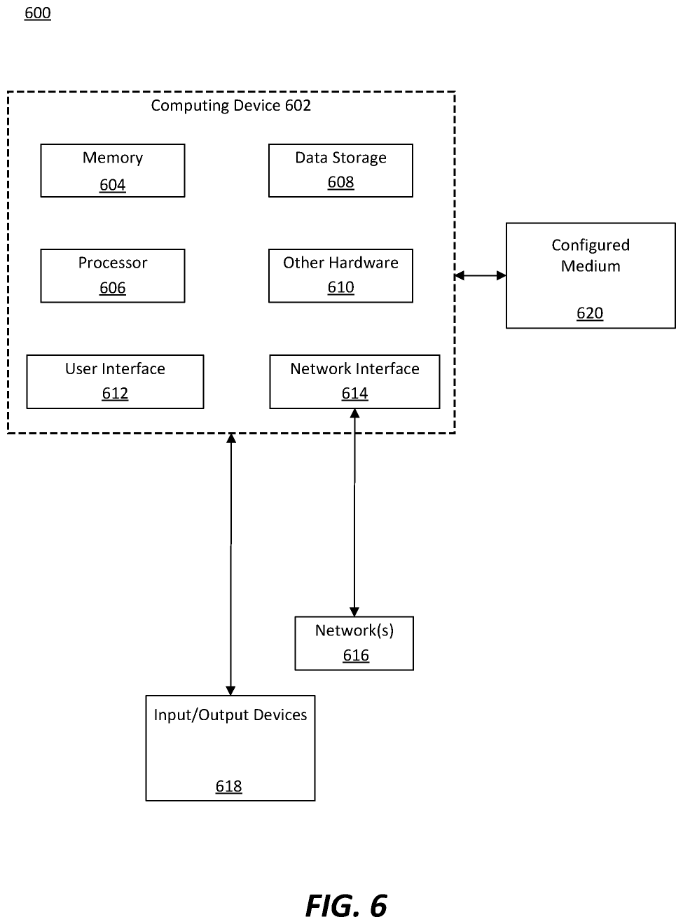

Process 500 can be performed (e.g., executed) by a system, such as system 100 of FIG. 1, or any computing device. In some embodiments, process 500 can be implemented using at least one processor (e.g., processor 606 in FIG. 6), which may execute one or more instructions that can be stored on a computer-readable medium (e.g., data storage device 608 of FIG. 6). While the steps in FIG. 5 are shown in a particular exemplary order, it is appreciated that the individual steps may be reordered, omitted, and/or repeated. Steps described in process 500 may include performing operations described above with respect to FIG. 1.

In some embodiments, process 500 begins at step 503. At step 503, at least one processor may obtain input data, which may be obtained directly from external users. In some embodiments, obtaining data may comprise one or more of receiving data (e.g., from a local or remote source), requesting data, authenticating data or a data source, retrieving data (e.g., from a storage medium). The at least one processor may obtain input data 101a as in FIG. 1. Input data 101a may comprise at least one of text data, image data, video data, or web data (e.g., HTML data, which may have been extracted from a webpage). Input data 101a may comprise metadata or system data. The at least one processor may obtain content policy 101b as in FIG. 1. Content policy 101b may comprise one or more set of rules or guidelines for identifying and filtering content data. In some embodiments, the content data may comprise input data 101a. In some embodiments, the content data may comprise data from one or more types of content categories, such as sexual content, hateful content, violence (violent content), self-harm content, or harassment content. A content policy may include at least one of an instruction, a defined task, or any combination of parameters that set one or more constraints on language model output. In some embodiments, a content policy may include user-specified natural language instructions, which may be interpretable by a language model, even though formed in natural language format. For instance, a user instruction may comprise an instruction to filter out content data classified within a certain category, such as hateful content or sexual content. In some embodiments, user input data or user instruction may correspond to a particular language model application framework (e.g., which may include a digital text pattern, format, structure, or style). In some embodiments, an Application Programming Interface (API) may define the particular language model application framework. The at least one processors may also obtain cold start data 101c as in FIG. 1. Cold start data 101c may be multi-domain data, comprising data from a plurality of data sources, such as one or more of public domain data, production data, academic data, crawled web data, metadata, or hybrid data. In some embodiments, cold start data 101c may comprise machine-generated data and/or human-curated synthetic data. In some embodiments, human-curated synthetic data may be generated using a prompt template as exemplified by FIG. 3. In some embodiments, cold start data 101c may be used by a training data engine such as training data generation engine 106 to generate cold start data to be used through an active learning and/or labelling process for a language model.

At step 507, the at least one processor may the at least one processor may generate a content taxonomy, which may be based on input data and one or more content policies. The at least one processor may receive input data as exemplified by input data 101a (which may include data from a plurality of sources such as web sources or public domain sources, as described herein). In some embodiments, the at least one processor may receive one or more content policies as exemplified by content policy 101b. The at least one processor may automatically generate a taxonomy of content based on input data 101a and content policy 101b. For example, input data 101a may be analyzed, manipulated, and/or used (e.g., to influence a machine learning model) while using content policy 101b as a constraint (e.g., on machine learning model operation or a training process). A taxonomy may be, include, or be represented by, a data structure, which may include interrelated data elements (e.g., digital layers and/or nodes, which may correspond to categories and/or sub-categories, input data, output data), which may be related or configured through AI-generated relationships. In some embodiments, the taxonomy generated may comprise undesired content which may undergo content moderation. In some embodiments, the taxonomy generated may comprise one or more content categories such as sexual content, hateful content, or violent content, as exemplified by FIG. 2. In some embodiments, the taxonomy generated may further comprise one or more content sub-categorical layers. For instance, a content category of sexual content [S] may be defined as content that depicts explicit or implicit sexual behavior. The content category of sexual content [S] may comprise a sub-categorical layer further comprising [S3] sexual content involving minors, [S2] content that depicts certain sexual activities which could be illegal if they happened in real life today, and [S1] erotic sexual content that does not depict illegal activities and [S0] nonerotic or contextualized sexual content, such as medical or sex education material. In some embodiments, a subset of sub-categories within a sub-categorical layer may be labelled as “undesired”, such as S1-S3 above. In some embodiments, the labelling of categories or sub-categories may be based on one or more content policies as exemplified by content policy 101b in FIG. 1. In some embodiments, a subset of sub-categories within a sub-categorical layer may not receive the “undesired” label. In another example, a content category of hateful content [H] may comprise content that is threatening, insulting, derogatory and otherwise abusive content targeting specific chosen groups or members of the group because of their group identifies. Content category hateful content [H] may comprise a sub-categorical layer comprising undesired sub-categories such as [H2] hateful content calling for violence or threatening, [H1] derogatory stereotypes or support for hateful statements, and/or subcategories that are not considered as undesired, such as [H0.a] neutral statement referring to group identity and [H0.b] contextualized hate speech, such as a quote of other individual's statement in order to provide commentary. In another example, a content category of violence [V] may comprise content that depicts or shows support for physical violence. The content category of violence [V] may comprise a sub-categorical layer comprising undesired sub-categories such as [V2] extremely graphic violence and [V1] threats or support for violence, and/or sub-categories such as [V0] neutral depictions of contextualized violence which may not be considered undesired. In some embodiments, the categories or sub-categories in a sub-categorical layer may be ranked by a metric. In some embodiments, the metric may comprise a measure of a degree to which the content is desired or undesired or a prediction of the content as including desired or undesired digital material. In some embodiments, the metric may be user-defined or machine-generated. In some embodiments, the metric may be automatically generated based on training data or cold start data as exemplified by cold start data 101c. It is appreciated that this automatic taxonomy generation and/or automatic metric-based ranking of generated content categories and sub-categories within the taxonomy implements a solution rooted in computer technology rather than simply following rules, and contribute to solving the complex problem of content taxonomy generation and ranking across multiple types of categories and sub-categorical layers.

At step 511, the at least one processor may receive unlabeled data or raw data such as one or more of public domain data, production data, academic data, crawled web data, metadata, or hybrid data, as exemplified by cold start data 101c. In some embodiments, the at least one processor may receive (or access, such as from a storage device) training data, such as multi-domain training data (e.g., cold start data) from a plurality of data sources. In some embodiments, training data may comprise crawled data or data mined from one or more web sources, such as HyperText Markup Language (HTML) data or JavaScript data, which is often impractical for human users to analyze, process, and manipulate. Additionally or alternatively, training data may comprise one or more of public-domain data, machine-generated data based on a language model, or human-curated synthetic data. In some embodiments, the at least one processor may annotate the received cold start data. For instance, the at least one processor may perform tokenization, lemmatization, part-of-speech tagging of the received cold start data, metadata generation, and/or any operation to modify distinguish certain data. In some embodiments, the at least one processor may perform additional normalization of the received cold start data, including but not limited to foreign language translation, conversion of system data or meta data, or masking of personal identifiable information. In some embodiments, the at least one processor may generate a set of training data based on input data 101a and/or cold start data 101c. In some embodiments, the at least one processor may generate a set of training data. For example, the at least one processor may generate a set of training data based on multi-domain data from a plurality of data sources, such as one or more of crawled data, public-domain data, academic data, system data, metadata, or hybrid data. It is appreciated that this generation of training data from multiple data domains and data types improves natural-language-based machine learning model training by improving efficiency and resource usage.

At step 513, the at least one processor may access a language model based on one or more desired output behaviors or user intent. In some embodiments, the desired output behaviors or user intent may be represented by one or more content policies as exemplified by content policy 101b. In some embodiments, the at least one processor may access a language model based on one or more content policies derived from content policy 101b. For example, a plurality of language models may be associated with different content policies and/or content policy attributes, and may be searchable by the at least one processor according to the content policies and/or content policy attributes. In some embodiments, the at least one processor may access a language model based on a set of user-defined or system-defined model parameters. In some embodiments, the at least one processor may access a language model based on the output of content classification as performed by content classification engine 110 or the validated output from output validation engine 112. In some embodiments, the at least one processor may access the language model based on a training dataset produced by training data generation engine 106, which may include sample data input. In some embodiments, the training dataset may also include sample output data based on the sample data input. In some embodiments, the training dataset may also include annotated data, labeled data, or other types of enriched or augmented data. In some embodiments, accessing (or training, as the case may be) the language model may include at least one of adding, removing, modifying a model parameter of the language model, or any other model training operation discussed below (e.g., based on an instruction, input data, or content policy), such as with respect to FIG. 7. For example, the at least one processor may add, deactivate. or remove a node and/or layer of the model. As another non-mutually exclusive example, the at least one processor may add or remove a connection between nodes within the language model. In some embodiments, the at least one processor may execute (e.g., perform) access of the language model based on a set of demonstration data. In some embodiments, the at least one processor may use the cold start data or other multi-domain data as validation data to determine quality scores or other metrics of model output, to train a language model to perform improved content classification. It is appreciated that this automatic validation and training of the language model improves natural-language-based machine learning model training and output by improving efficiency and accuracy. In some embodiments, the at least one processor may execute (e.g., perform) alignment using a machine learning algorithm. In some embodiments, the machine learning algorithm may include a reinforcement learning algorithm, such as proximal policy optimization. In some embodiments, aligning the language model may include maximizing a helpfulness metric of one or more model outputs. In some embodiments, a helpfulness metric of the one or more outputs may be computed (e.g., by at least one processor) based on labelled data (e.g., by executing one or more comparisons between one or more outputs and the labelled data associated with respective helpfulness metrics). In some embodiments, the labelled data may comprise human-curated synthetic data or machine-generated data based on a language model. In some embodiments, aligning the language model may include maximizing an outcome metric of one or more model outputs. In some embodiments, the outcome metrics of the one or more outputs may be computed based on user-labeled data (e.g., by executing one or more comparisons between one or more outputs and user-labeled data associated with respective outcome metrics). In some embodiments, the language model is configured to output the language model output based on at least one of a sampling temperature parameter or a nucleus sampling parameter. In some embodiments, the language model is configured to output language model output based on the probability of the output in a probability distribution of a sampling temperature parameter or a nucleus sampling parameter. In some embodiments, the language model output may comprise a probability of one or more classifications of input data as exemplified by input data 101a.

At step 515, the at least one processor may receive data from language model access engine 108 and data from taxonomy generation engine 104 to perform content classification of the input data 101a. In some embodiments, the at least one processor may classify the content of the input data (e.g., input data 101a), such as by using the language model and the content taxonomy. In some embodiments, the at least one processor may perform classification of input data based on the taxonomy generated by taxonomy generation engine 104. The taxonomy may comprise one or more categories and/or sub-categorical layers which comprise one or more sub-categories. For instance, the at least one processor may classify input data as sexual content [S], hateful content [H], and/or violence [V]. The at least one processor may further classify input data under the [S] category as non-erotic or contextualized sexual content [S0], erotic content without depiction of illegal activities [S1], content depicting certain activities which could be illegal in real life [S2], and/or or sexual content involving minors [S3], as illustrated in FIG. 2. In some embodiments, the at least one processor may classify input data into one or more categories and/or sub-categories within one or more sub-categorical layers. In some embodiments, the at least one processor may classify (e.g., annotate, to influence machine learning training and/or configuration) input data as “undesired” based on its associated categories and/or sub-categories. For instance, under the category [S], input data of sub-categories [S1], [S2], and [S3] may be classified as “undesired” while input data of sub-sub-category [S0] may not be classified as “undesired.”

At step 517, the at least one processor may receive output content classifications from content classification engine 110 to perform output validation. In some embodiments, the at least one processor may receive one or more of a set of language model outputs, user-labelled outputs, or a set of comparison data. In some embodiments, the at least one processor may execute a ranking of the received outputs based on a set of user instructions or one or more content policies as exemplified by content policy 101b. Additionally or alternatively, the at least one processor may execute ranking based on a set of training data generated by training data generation engine 106 or cold start data 101c. Additionally or alternatively, the at least one processor may rank the received outputs based on an outcome metric. In some embodiments, an outcome metric may comprise a numerical scoring of the content classification from content classification engine 110 based on human-labelled data. An outcome metric may comprise machine-generated metrics based on one or more training data sets or multi-domain data. An outcome metric may comprise a similarity metric between the classification of the input data as received by content classification engine 110 and human-curated synthetic data. In some embodiments, the at least one processor may rank the received outputs based on a proximity metric to one or more desired output behaviors or one or more content policies (e.g., represented in Euclidean space). In some embodiments, a model may be trained, updated, aligned, or refined using one or more proximity metrics. In some embodiments, a model may validate the received outputs by identifying mislabeled data, which may include at least one of using cross validation or token subtraction. In some embodiments, the received outputs may comprise training data generated by training data generation engine 106, or input data 101a, as illustrated in FIG. 1.

At step 519, the at least one processor may perform data refinement or optimization. For example, the at least one processor may re-normalize the training data, and the re-normalization may be based on language model-generated data or human-curated synthetic data. In some embodiments, the at least one processor may perform overfitting phrase detection, to identify overfitted phrases in the training data using machine-generated data based on the language model or human-curated synthetic data. For example, the at least one processor may identify overfitted phrases by using token-subtraction or other input reduction techniques. Additionally or alternatively, the at least one processor may identify overfitted phrases by using an adversarial approach such as red-teaming via human trials.

The at least one processor may also (e.g., in step 519) perform mislabeling detection and identify input data or training data that has been incorrectly classified by content classification engine 110. In some embodiments, the at least one processor may identify mislabels using cross-validation or overfitted tokens or phrases identified by overfitting phrase detection engine 114a.

The at least one processor may also (e.g., in step 519) perform data augmentation. Data augmentation may include modifying data (e.g., training data or other input data), replacing data (e.g., replacing elements of training data or other input data), removing data (e.g., removing portions of training data or other input data to improve model training), or other operation to curate data to be used for model training. In some embodiments, the at least one processor may perform data augmentation by generating synthetic data using a language model (e.g., to be used for training a different language model). In some embodiments, data augmentation may be performed based on a determined data distribution of the data set. In some embodiments, the at least one processor may perform data distribution analysis based on the distribution of data samples classified by content classification engine 110 for each category and/or sub-category within the content taxonomy as generated by taxonomy generation engine 104. In some embodiments, the at least one processor may base the data distribution analysis on the number of data samples within the data set classified as “undesired” by content classification engine 110. In some embodiments, the at least one processor may base the data distribution analysis on the frequency of irrelevant symbols, typos, or adversarial inputs in the data set. For instance, the at least one processor may generate synthetic data for aspects of the data set which is sparse based on the data distribution, such as data for a particular type of category or sub-category. In some embodiments, the at least one processor may utilize one or more prompt templates to generate synthetic data as illustrated in FIG. 3.

The at least one processor may also perform (e.g., in step 519) fairness & bias improvement and perform bias identification of the output content classification as performed by content classification engine 110. The at least one processor may perform bias identification using demographical data based on one or more attributes. In some embodiments, demographical data may comprise data based on gender, age, or sexual orientation. In some embodiments, the at least one processor may For instance, the at least one processor may identify that the current language model used by content classification engine 110 generates higher percentage of hateful content [H] labels if the input data contains the word “gay”, or higher percentage of sexual content [S] labels if the input data contains “her.” In some embodiments, the at least one processor may refine the training data set by performing overfitting reduction, mislabeling correction, training data augmentation, or any combination thereof.

Also in step 519, the at least one processor may perform optimization by aligning or fine-tuning a language model from language model access engine 108, based on one or more desired output behaviors or user intent derived from a set of user instructions, or one or more content policies as exemplified by content policy 101b. In some embodiments, the at least one processor may align a language model based on the validated outputs from output validation engine 112 or the refined data set from data refinement engine 114. In some embodiments, aligning the language model may include at least one of adding, removing, modifying a model parameter of the language model, or any other model training operation discussed below, for example with respect to FIG. 7. For example, the at least one processor may add, deactivate, or remove a node and/or layer of the model. As another non-mutually exclusive example, the at least one processor may add or remove a connection between nodes within the language model. In some embodiments, the at least one processor may execute (e.g., perform) the alignment of the language model based on a set of machine-generated data based on a language model or human-curated synthetic data. In some embodiments, the at least one processor may use refined data as validation data to determine quality scores or other metrics of model output, to train a language model to generate improved digital text outputs or content classification. In some embodiments, the at least one processor may execute (e.g., perform) alignment using a machine learning algorithm. In some embodiments, the machine learning algorithm may include a reinforcement learning algorithm, such as proximal policy optimization. In some embodiments, aligning the language model may include maximizing a helpfulness metric of one or more model outputs. In some embodiments, a helpfulness metric of the one or more outputs may be computed (e.g., by at least one processor) based on labelled data (e.g., by executing one or more comparisons between one or more outputs and the labelled data associated with respective helpfulness metrics). In some embodiments, the labelled data may comprise human-curated synthetic data or machine-generated data based on a language model. In some embodiments, aligning the language model may include maximizing an outcome metric of one or more model outputs. In some embodiments, the outcome metrics of the one or more outputs may be computed based on user-labeled data (e.g., by executing one or more comparisons between one or more outputs and user-labeled data associated with respective outcome metrics). In some embodiments, the language model is configured to output the language model output based on at least one of a sampling temperature parameter or a nucleus sampling parameter. In some embodiments, the language model is configured to output language model output based on the probability of the output in a probability distribution of a sampling temperature parameter or a nucleus sampling parameter. In some embodiments, the language model output may comprise a probability of one or more classifications of input data as exemplified by input data 101a.

Also in step 519, the at least one processor may undergo iterative training and optimization of the language model. In some embodiments, the at least one processor may perform iterative training and optimization until a threshold value (e.g., model performance metric value, validation data agreement value) has been reached. For example, the language model may be refined or optimized through one or more iterative cycles of training, which may be based on or more datasets (e.g., different datasets, such as different input or validation data). A cycle of training may include one or more rounds of training, one or more epochs of training, or any number of discrete training operations. In other embodiments, the at least one processor may perform training and optimization of the language model in a non-iterative manner. Alternatively, the language model may already be trained and/or optimized. The at least one processor may also train and optimize the language model by aligning a language model (e.g., the selected language model) to one or more desired output behavior (e.g., user intent, textual context, or one or more content policies as in 101b). The at least one processor may use the refined language model and content classification engine 110 to generate a set of refined content classifications for input data 101a in iterative cycles of generation, validation, and refinement. In some embodiments, the threshold value may comprise a numerical score or a matrix generated by LM probing engine 118 or output validation engine 112 as in FIG. 1.

At step 521, the at least one processor may probe the accessed language model by language model access engine 108 or the refined language model by LM refinement engine 116. In some embodiments, the at least one processor may probe the refined language model using key tokens probing to identify potentially over-fitted key tokens within the training data. In some embodiments, the at least one processor may also apply token subtraction or other input reduction techniques. In some embodiments, the at least one processor may probe the refined language model using human verification and/or adversarial approaches such as red-teaming via human trials.

At step 523, the at least one processor may perform content moderation on input data (e.g., input data 101a) by filtering the input data. Filtering the input data may include modifying input data, removing input data, adding data to the input data, or otherwise changing the composition of the input data. For example, the filtering may be based on the categories and/or subcategories of the input data classified as “undesired” by content classification engine 110. In some embodiments, the at least one processor may perform content moderation by generating warnings to the user based on the categories and/or subcategories of the input data classified as “undesired” by content classification engine 110. In some embodiments, the at least one processor may edit the input data to minimize the undesired content as classified by content classification engine 110.

FIG. 6 is a block diagram illustrating an exemplary operating environment for implementing various aspects of this disclosure, according to some embodiments of the present disclosure.

An exemplary operating environment for implementing various aspects of this disclosure is illustrated in FIG. 6. As illustrated in FIG. 6, an exemplary operating environment 600 may include a computing device 602 (e.g., a general-purpose computing device) in the form of a computer. In some embodiments, computing device 602 may be associated with a user. Components of the computing device 602 may include, but are not limited to, various hardware components, such as one or more processors 606, data storage 608, a system memory 604, other hardware 610, and a system bus (not shown) that couples (e.g., communicably couples, physically couples, and/or electrically couples) various system components such that the components may transmit data to and from one another. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 6, an operating environment 600 for an exemplary embodiment includes at least one computing device 602. The computing device 602 may be a uniprocessor or multiprocessor computing device. An operating environment 600 may include one or more computing devices (e.g., multiple computing devices 602) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 602 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 602 by using a display, keyboard, mouse, microphone, touchpad, camera, sensor (e.g., touch sensor) and other input/output devices 618, via typed text, touch, voice, movement, computer vision, gestures, and/or other forms of input/output. An input/output device 618 may be removable (e.g., a connectable mouse or keyboard) or may be an integral part of the computing device 602 (e.g., a touchscreen, a built-in microphone). A user interface 612 may support interaction between an embodiment and one or more users. A user interface 612 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other NUI may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, game port or a universal serial bus (USB). A monitor or other type of display device is also connected to the system bus via an interface, such as a video interface. The monitor may also be integrated with a touchscreen panel or the like. Note that the monitor and/or touch screen panel can be physically coupled to a housing in which the computing device is incorporated, such as in a tablet-type personal computer. In addition, computers such as the computing device may also include other peripheral output devices such as speakers and printer, which may be connected through an output peripheral interface or the like.

One or more application programming interface (API) calls may be made between input/output devices 618 and computing device 602, based on input received from at user interface 612 and/or from network(s) 616. As used throughout, “based on” may refer to being established or founded upon a use of, changed by, influenced by, caused by, or otherwise derived from. In some embodiments, an API call may be configured for a particular API, and may be interpreted and/or translated to an API call configured for a different API. As used herein, an API may refer to a defined (e.g., according to an API specification) interface or connection between computers or between computer programs.

System administrators, network administrators, software developers, engineers, and end-users are each a particular type of user. Automated agents, scripts, playback software, and the like acting on behalf of one or more people may also constitute a user. Storage devices and/or networking devices may be considered peripheral equipment in some embodiments and part of a system comprising one or more computing devices 602 in other embodiments, depending on their detachability from the processor(s) 606. Other computerized devices and/or systems not shown in FIG. 1 may interact in technological ways with computing device 602 or with another system using one or more connections to a network 616 via a network interface 614, which may include network interface equipment, such as a physical network interface controller (NIC) or a virtual network interface (VIF).

Computing device 602 includes at least one logical processor 606. The computing device 602, like other suitable devices, also includes one or more computer-readable storage media, which may include, but are not limited to, memory 604 and data storage 608. In some embodiments, memory 604 and data storage 608 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 620 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 602, making its content accessible for interaction with and use by processor(s) 606. The removable configured medium 620 is an example of a computer-readable storage medium. Some other examples of computer-readable storage media include built-in random access memory (RAM), read-only memory (ROM), hard disks, and other memory storage devices which are not readily removable by users (e.g., memory 604).

The configured medium 620 may be configured with instructions (e.g., binary instructions) that are executable by a processor 606; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 620 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 610 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 606 (e.g., one or more CPUs, ALUs, FPUs, and/or GPUs), memory 604, data storage 608, and screens/displays, an operating environment 600 may also include other hardware 610, such as batteries, buses, power supplies, wired and wireless network interface cards, for instance. The nouns “screen” and “display” are used interchangeably herein. A display may include one or more touch screens, screens responsive to input from a pen or tablet, or screens which operate solely for output. In some embodiment, other input/output devices 618 such as human user input/output devices (screen, keyboard, mouse, tablet, microphone, speaker, motion sensor, etc.) will be present in operable communication with one or more processors 606 and memory.

In some embodiments, the system includes multiple computing devices 602 connected by network(s) 616. Networking interface equipment can provide access to network(s) 616, using components (which may be part of a network interface 614) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 602 may operate in a networked or cloud-computing environment using logical connections to one or more remote devices (e.g., using network(s) 616), such as a remote computer (e.g., another computing device 602). The remote computer may include one or more of a personal computer, a server, a router, a network PC, or a peer device or other common network node, and may include any or all of the elements described above relative to the computer. The logical connections may include one or more LANs, WANS, and/or the Internet.

When used in a networked or cloud-computing environment, computing device 602 may be connected to a public or private network through a network interface or adapter. In some embodiments, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

The computing device 602 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer. Communication media may embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of the any of the above may also be included within the scope of computer-readable media. Computer-readable media may be embodied as a computer program product, such as software (e.g., including program modules) stored on non-transitory computer-readable storage media.

The data storage 608 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 608 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Exemplary disclosed embodiments include systems, methods, and computer-readable media for the generation of text and/or code embeddings. For example, in some embodiments, and as illustrated in FIG. 6, an operating environment 600 may include at least one computing device 602, the at least one computing device 602 including at least one processor 606, at least one memory 604, at least one data storage 608, and/or any other component discussed below, such as with respect to FIG. 6.

FIG. 7 is a block diagram illustrating an exemplary machine learning platform for implementing various aspects of this disclosure, according to some embodiments of the present disclosure.

System 700 may include data input engine 710 that can further include data retrieval engine 704 and data transform engine 706. Data input engine 710 may be configured to access, interpret, request, format, re-format, or receive input data from data source(s) 702. Data source(s) 702 may include one or more of training data 702a (e.g., input data to feed a machine learning model as part of one or more training processes), validation data 702b (e.g., data against which at least one processor may compare model output with, such as to determine model output quality), and/or reference data 702c. In some embodiments, data input engine 710 can be implemented using at least one computing device (e.g., computing device 602). For example, data from data sources 702 can be obtained through one or more I/O devices and/or network interfaces. Further, the data may be stored (e.g., during execution of one or more operations) in a suitable storage or system memory. Data input engine 710 may also be configured to interact with data storage 608, which may be implemented on a computing device that stores data in storage or system memory. System 700 may include featurization engine 720. Featurization engine 720 may include feature annotating & labeling engine 712 (e.g., configured to annotate or label features from a model or data, which may be extracted by feature extraction engine 714), feature extraction engine 714 (e.g., configured to extract one or more features from a model or data), and/or feature scaling and selection engine 716. System 700 may also include machine learning (ML) modeling engine 730, which may be configured to execute one or more operations on a machine learning model (e.g., model training, model re-configuration, model validation, model testing), such as those described in the processes described herein. For example ML modeling engine 730 may execute an operation to train a machine learning model, such as adding, removing, or modifying a model parameter. Training of a machine learning model may be supervised, semi-supervised, or unsupervised. Data into to a model to train the model may include input data (e.g., as described above) and/or data previously output from a model (e.g., forming recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. ML modeling engine 730 may include model selector engine 732 (e.g., configured to select a model from among a plurality of models, such as based on input data), parameter selector engine 734 (e.g., configured to add, remove, and/or change one or more parameters of a model), and/or model generation engine 736 (e.g., configured to generate one or more machine learning models, such as according to model input data, model output data, comparison data, and/or validation data). Similar to data input engine 710, featurization engine 720 can be implemented on a computing device. In some embodiments, model selector engine 732 may be configured to receive input and/or transmit output to ML algorithms database 790 (e.g., a data storage 608). Similarly, featurization engine 720 can utilize storage or system memory for storing data and can utilize one or more I/O devices or network interfaces for transmitting or receiving data. ML algorithms database 790 (or other data storage 608) may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model, a linear regression model, a k-means clustering model, a Q-Learning model, a Temporal Difference (TD) model, a Deep Adversarial Network model, or any other type of model described further herein.

System 700 can further include predictive output generation engine 740, output validation engine 750 (e.g., configured to apply validation data to machine learning model output), feedback engine 770 (e.g., configured to apply feedback from a user and/or machine to a model), and model refinement engine 760 (e.g., configured to update or re-configure a model). In some embodiments, feedback engine 770 may receive input and/or transmit output to outcome metrics database 780. In some embodiments, model refinement engine 760 may receive output from predictive output generation engine 740 or output validation engine 750. In some embodiments, model refinement engine 760 may transmit the received output to featurization engine 720 or ML modeling engine 730 in one or more iterative cycles.

Any or each engine of system 700 may be a module (e.g., a program module), which may be a packaged functional hardware unit designed for use with other components or a part of a program that performs a particular function (e.g., of related functions). Any or each of these modules may be implemented using a computing device. In some embodiments, the functionality of system 700 may be split across multiple computing devices to allow for distributed processing of the data, which may improve output speed and reduce computational load on individual devices. In these or other embodiments, the different components may communicate over one or more I/O devices and/or network interfaces.

System 700 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. A system comprising:
at least one memory storing instructions; and
at least one processor configured to execute the instructions to perform first operations for automatically classifying and moderating content, the operations comprising:
receiving input data;
receiving one or more content policies;
generating a content taxonomy using a large language model generation engine configured to receive the input data and the one or more content policies and generate the content taxonomy by forming categories and subcategories ranked with a prediction metric predictive of content including desired or undesired digital material, the metric being automatically machine-generated;
receiving multi-domain cold start data from a plurality of data sources;
generating training data based on the multi-domain cold start data to initiate an active learning process, the active learning process being performed based on two or more parallel learning pipelines;
accessing a pre-trained language model based on the input data and the training data;
iteratively executing second operations until a threshold value has been reached to generate an optimized language model, wherein the second operations comprise:
classifying the content of the input data using the pre-trained language model and the content taxonomy;
refining the training data based on the classified content of the input data;
refining the pre-trained language model based on the refined training data to generate the optimized language model; and
probing the optimized language model; and
moderating the content of the input data based on the optimized language model and the content taxonomy.

2. The system of claim 1, wherein:
generating the training data comprises annotating data;
the input data comprises prompts generated from prompt templates; and
moderating the content comprises filtering input prompts using the optimized language model.

3. (canceled)

4. The system of claim 1, wherein:
the plurality of categories further comprise sub-categorical layers;
the desirable categories comprise at least two desirable sub-categorical layers.

5. (canceled)

6. The system of claim 1, wherein the training data comprises at least one of machine-generated data or human-curated synthetic data.

7. The system of claim 1, wherein refining the training data comprises validating the training data and input data using at least one of cross validation or token subtraction.

8. The system of claim 1, wherein refining the training data further comprises re-normalizing the training data based on language model-generated data.

9. The system of claim 1, wherein probing the optimized language model comprises key token probing and human verification.

10. The system of claim 1, wherein moderating the content of the input data comprises filtering the content of the input data.

11. A method for automatically classifying and moderating content, comprising:
receiving input data;
receiving one or more content policies;
generating a content taxonomy using a large language model configured to receive the input data and the one or more content policies and generate the content taxonomy by forming categories and subcategories ranked with a prediction metric predictive of content including desired or undesired digital material, the metric being automatically machine-generated;
receiving multi-domain cold start data from a plurality of data sources;
after generating the content taxonomy, generating training data based on the multi-domain cold start data to initiate an active learning process, the active learning process being performed based on two or more parallel learning pipelines;
accessing a pre-trained language model based on the input data and the training data;
after generating the training data, generate an optimized language model by iteratively executing operations until a threshold value has been reached, wherein the operations comprise:
classifying the content of the input data in at least one of the plurality of categories using the pre-trained language model;
refining the training data based on the classified content of the input data;
refining the pre-trained language model based on the refined training data to generate the optimized language model; and
probing the optimized language model; and
moderating the content of the input data based on the optimized language model and the content taxonomy.

12. The method of claim 11, wherein generating the training data comprises annotating data.

13. (canceled)

14. (canceled)

15. (canceled)

16. The method of claim 11, wherein the training data may comprise machine-generated data or human-curated synthetic data.

17. The method of claim 11, wherein refining the training data comprises validating the training data and input data using token subtraction.

18. The method of claim 11, wherein refining the training data further comprises re-normalizing the training data based on language model-generated data or human-curated synthetic data.

19. The method of claim 11, wherein probing the optimized language model comprises key tokens probing and human verification.

20. The method of claim 11, wherein moderating the content of the input data comprises filtering the content of the input data.

21. The system of claim 1, wherein the two or more pipelines comprise:
a first pipeline configured to perform a random sampling of the cold start data; and
a second pipeline configured to perform random sample selections for each category

22. The system of claim 21, wherein the two or more pipelines comprise a third pipeline configured to adopt a set of algorithms for capturing uncertain samples.

23. The system of claim 1, wherein probing the optimized language model comprises applying one or more key tokens to identify over-fitted key tokens within the training data.

24. The system of claim 1, wherein probing the optimized language model comprises applying token subtraction on a training data-set.

25. A generative artificial intelligence system, the system comprising:
a server connected to a network comprising at least one processor configured to:
receive a content policy;
generate, using a generation engine, a content taxonomy based on the content policy, the content taxonomy comprising a plurality of desirable content categories and a plurality of undesirable content categories;
generate training data based on multi-domain data, the multi-domain data comprising unlabeled data;
train a moderation model using the training data by:
initializing the moderation model from at least one generative pre-trained transformer;
classifying content in the plurality of desirable content categories and the plurality of undesirable content categories according to the content taxonomy using the moderation model;
generating an outcome metric based on a proximity between classified content and the content taxonomy; and
fine-tuning the moderation model by adding or removing at least one of a node or a layer in the moderation model based on the outcome metric; and
filtering input prompts to a large language model using the moderation model.
